(19) United States
(12) Patent Application Publication
(10) Pub. No.: US 2016/0053528 A1
(43) Pub. Date: Feb. 25, 2016

(54) COMPOSITE ELEMENT, IN PARTICULAR COMPOSITE ELEMENT FOR AN INSULATING-GLASS UNIT

(71) Applicant: SIKA TECHNOLOGY AG, Baar (CH)

(72) Inventors: Matthias DICK, Zurich (CH); Anton ETTLIN, Watt (CH)

(73) Assignee: SIKA TECHNOLOGY AG, Baar, OT (CH)

(21) Appl. No.: 14/781,206

(22) PCT Filed: May 14, 2014
(86) PCT No.: PCT/EP2014/059873

§ 371 Date: Sep. 29, 2015

(30) Foreign Application Priority Data
May 14, 2013 (EP) 13167732.0

(51) Int. Cl. E06B 3/663; E06B 3/677; E06B 3/673; E06B 3/02; E06B 3/66

(52) U.S. Cl. CPC E06B 3/66304; E06B 3/025; E06B 3/6612; E06B 3/673; E06B 3/677

(57) ABSTRACT

A composite element is disclosed, such as a composite element for an insulating-glass unit, including a first pane element and at least one second pane element and at least one first profile element, wherein the profile element has at least one first connecting surface and/or at least one second connecting surface, wherein the first and/or the second connecting surface are/is provided for applying and/or accommodating a first connecting device, adjacent the first connecting surface is a third connecting surface for applying and/or accommodating a second connecting device, and/or adjacent the second connecting surface is a fourth connecting surface for applying and/or accommodating a second connecting device. The first pane element and the second pane element can be connected by the profile element, the first connecting device, and/or the second connecting device.

### TECHNICAL FIELD

The present invention relates to a composite element, in particular, a composite element for an insulating-glass unit, an insulating-glass unit, a profile element, a window, a door, as well as a method for producing a composite element, respectively, an insulating-glass unit.

### PRIOR ART

Insulating-glass units are already known from the prior art.

Multi-pane insulating glass (MIG), also referred to as thermal insulation glazing or insulation glazing, is a structural element composed of at least two glass panes for, e.g. windows. Situated between the panes is a hollow cavity, which is hermetically sealed and serves as thermal insulation. These were preceded by the double glazing without the air seal, the so-called composite window and, in the case of casement windows or outer (winter) windows, the double individual glass panels.

Unlike other thermally insulating types of glazing, the insulation glazing is an independent system, which does not require a surrounding frame—generally a casement—for proper functioning. This is achieved by means of an edge seal which holds the individual glass panes together at a distance from one another and at the same time hermetically seals the space between the panes. For many years, the space between the panes has not included air, but rather, e.g. the normally better insulating inert gas argon.

In order to minimize the thermal conduction of an insulating-glass unit, it is possible to enlarge the space between the panes. However, at increasing volumes gases transfer quantities of heat not only through thermal conduction (conduction), but also through airflow (convection), thus the thermal insulation resulting from the enclosed gas deteriorates again beyond a certain spacing between panes. To prevent this, an additional (third) glass pane is installed in the insulating glass.

The task of the edge seal is to mechanically hold the glass panes together at a distance from one another, and to prevent the charge of gas from escaping and ambient air and humidity from entering in its place.

Initially in the technical development of the double insulating glass, a metal spacer was soldered in place between the two panes. Another method consisted of simultaneously melting and bending the glass edges in order to thereby fuse the individual panes of glass together.

For decades, an edge seal glued in two stages has been the norm, however. A profile made of aluminum, stainless steel or plastic 10 to 20 mm wide—the so-called spacer—is provided on both sides with a sticky layer of butyl rubber. It bonds the panes to one another after being forcefully pressed together, and at the same constitutes the first sealing layer. A door leaf made of two glass panes is described in DE 102 11 940 A1, for example, in which the glass panes are connected via a profile situated at the edges of the glass panes. Provided in each case as an adhesive and moisture barrier layer between the profile and the glass pane is a butyl rubber material, which is intended to protect the interior of the door leaf against moisture penetrating from the outside.

Once the space between the panes is filled with gas, the gap between the periphery of the spacer and the projecting glass edges is provided with a second permanently elastic sealing layer made of polyurethane or special polysulfides. In the case of façade elements which at this location are exposed to UV light, silicone is used which is more permeable to gas, however. One example of the use of sealing compounds made of polysulfide or silicone is found in EP 0 852 280 A1, which involves spacers for multi-pane insulation glazings. The spacers described therein are characterized by a metal foil attached to the entire bonding surface that faces away from the glazing space.

The edge seal ensures the proper functioning of the insulating-glass unit for only a certain period of time, since the diffusion of gases through a glued edge seal cannot be fully prevented. This results in a continual deterioration of the thermal insulation value as a result of the escaping filler gas—specified is a maximum 1% loss of gas annually—and ambient air and air moisture penetrate. A service life of 20 to 30 years is cited in the literature. To prevent the penetrating moisture from accumulating as condensate in the space between the panes, a desiccant derived from the materials family of silica gels or molecular sieves (zeolites) is integrated in the spacer, as is described in EP 0 228 641 A2, for example. Once the desiccant is depleted, the inside of the pane becomes fogged. This is referred to as a “blind pane”.

The edge seal degrades the thermal insulation of an insulating-glass unit. The thermal transition coefficient for insulating glass is expressed as an Ug-value (g=glazing) and fails to take into account take the effects of the edge seal. A double-insulating-glass unit of 1 m×1 m having a conventional spacer made of aluminum (psi value: 0.068 W/m·K) and an Ug value of 1.2 W/m²K, when including the effect of the edge seal, would have an U value of: 1.2 W/m² K+(4 m×0.068 W/m·K)=1.5 W/m²K.

The impairment of the thermal insulation value at the edge of the pane also leads to the accumulation of water condensation at the interior edge of the pane at low outside temperatures. (Since older windows often have a high joint permeability, the condensation is dried by the penetrating cold air and is then unnoticeable). When using a thermally improved edge seal—the so-called “warm edge” having psi values of 0.03 W/m·K to 0.05 Wm·K—the accumulation of condensation occurs only at lower outside temperatures, depending on the psi value and the air humidity.

However, the problem with the known insulating-glass units having the aforementioned two-step adhered edge seal is that these constructions must be designed at comparatively high expense and robustly with respect to the loads that occur, such as thermal expansion of the glass and of the spacer, the dead weight of the glass, live loads, such as wind pressure, suction and operating forces.

Thus, it is the object of the present invention to advantageously refine a composite element, in particular, a composite element for an insulating-glass unit, an insulating-glass unit, a profile element, a window, a door, as well as a method for producing a composite element or an insulating-glass unit, in particular so that an insulating-glass unit may be provided, which is particularly shear-resistant, but at the same time lightweight, stable and more cost-effective as a result of the material savings.

### Presentation of the Invention

According to the present invention, this object is achieved by a composite element having the features of claim 1. Accordingly, it is provided that a composite element includes at least one first pane element and at least one second pane element, as well as at least one first profile element, wherein the profile element includes at least one first connecting surface and/or at least one second connecting surface, wherein the first and/or the second connecting surface are/is provided and designed for applying and/or accommodating a first connecting means, and wherein provided adjacent the first connecting surface is a third connecting surface for applying and/or accommodating a second connecting means, and/or provided adjacent the second connecting surface is a fourth connecting surface for applying and/or accommodating a second connecting means, and wherein the first pane element and the second pane element may be connected or are connected by means of the profile element and the first connecting means and/or the second connecting means.

The composite element may, in particular, be a composite element for an insulating-glass unit. The profile element may, for example, be the spacer of an insulating-glass unit.

In particular, this has the advantage that a composite element comprising at least one first and at least one second pane element, which may be used, for example, in connection with insulating-glass units for windows or doors, is especially shear-resistant, but at the same time lightweight, stable and may be provided more cost effectively due to the material savings.

The first and the second pane element may, for example, be glass panes, or plastic panes.

In addition, it may be provided that the first connecting means has a hardness of approximately 60 shore A or greater or equal to 60 Shore A, in particular greater than or equal to approximately 70 Shore A, preferably greater than or equal to approximately 90 Shore A.

Shore hardness is a material characteristic for elastomers and plastics and is specified in the DIN 53505 and DIN 7868 and ISO 868 standards. The key element for the Shore hardness test unit is a spring-loaded pin made of tempered steel. The depth to which it penetrates into the material to be examined is a measure of the Shore hardness, which is measured on a scale from 0 Shore (2.5 millimeter penetration depth) to 100 Shore (0 millimeter penetration depth). A high number indicates extreme hardness. In the case of a Shore hardness test unit, an ancillary device may be employed, which presses the sample to be measured against the measuring table with a force of 12.5 Newtons at Shore-A, or of 50 Newtons at Shore-D. When determining the Shore hardness, the temperature plays a greater role than when determining the hardness of metallic materials. For that reason, in this case the target temperature of 23° C. is limited to the temperature interval of ±2 K. The material should have a thickness of least 6 millimeters. The hardness of the rubber is determined by the cross-linking (weakly cross-linked=soft rubber, strongly cross-linked=hard rubber). However, the concentration of fillers is also crucial for the hardness of the rubber product.

Moreover, it is possible for the first connecting means to be an adhesive, in particular a silicone-based adhesive, in particular a silicone.

It is preferable, however, if the adhesive used is a two-component adhesive system, in particular, a (meth)acrylate-based two-component adhesive system, which, for example, can be based on a so-called acrylic double performance (ADP) polymer technology. In such case, the first component contains a reactive monomer, for example, preferably in the form of an acrylate or methacrylate, in particular, in the form of a methacrylate, whereas the second component functions as an initiator, for example. Suitable initiators in this context are in particular peroxides such as dibenzoyl peroxide, for example. When using two-component adhesive systems, polymerization can advantageously occur during mixing with the aid of a static mixer.

Particularly preferred two-component adhesive systems are described in EP1427790A1 or EP1609831A1, for example, the disclosure of which is incorporated by reference in the present application.

A preferred commercially available adhesive is SikaFast® 5211, for example.

These two-component (meth)acrylate-based adhesive systems described above may also contain metal acrylates, in particular, in the form of zinc(meth)acrylate or calcium(meth)acrylate.

It is further conceivable that the second connecting means is and/or comprises [includes] at least partially polyisobutylene (PIB) and/or acryl.

Such a structure offers, among other things, the advantage that a particularly shear-resistant structure can be achieved. A significantly higher rigidity of the composite element combined with a minimal use of materials can be obtained through the use of a first “hard” connecting means, such as an adhesive.

In principle, it may be stated that the harder an adhesive is, the higher is also its shear modulus. For example, calculations and tests with two-component adhesive systems (SikaFast-5211) have been carried out and it was found that surprisingly a rigidity can be achieved which is approximately 10 times greater than compared to conventional constructions.

The stiffer the adhesive, the more shear-resistant the composite, but also the stresses in the glass and in the adhesive will be. High stresses can result in glass and adhesive fracture. Stresses in this case can arise as a result of the difference in the thermal expansion of the glass and of the spacer, of the dead weight of the glass, as a result of live loads, such as wind pressure, suction and operating forces.

It is therefore particularly important to select the stiffness of the adhesive such that in the case of an optimum composite structure, acceptable stresses in the glass and adhesive may still be transmitted. Important technical values are therefore the shear modulus of the adhesive, for example, which is also temperature dependent. Furthermore, the expansion coefficient between the glass and the spacer, the temperature differences between production and utilization of the pane, wind loads in relation to the glass surfaces, dead weights in relation to glass strengths and glass surfaces, stresses resulting from installation and use must also be considered. With this type of a structural glass bonding, a particularly protective glazing may be achieved, and the risk of glass breakage can be reduced.

Moreover, it is conceivable that the first and/or the second connecting surface is designed at least partially as a recess, in particular, as a recess, created in such a way that it is recessed relative to the third and/or fourth connecting surface, in particular recessed in relation to the support surface on the first or second pane element.

The recess may be a joint or a step-like recess, for example. The smaller the depth of the joint, the more shear-resistant the composite becomes. However, it is true that as the depth of the joint decreases, the stress in the adhesive and glass increases. For this reason, the calculation is not linear. The corner regions may be particularly critical, because it is there that the highest stresses can occur. At the same time, the joint width plays a comparatively minor role in terms of the shear-resistant composite. By sizing the joint width, it is possible to control the stress in the adhesive and the glass. Here, it is true that the larger the area (a result of the joint width and circumference), the lower the stress in the adhesive joint and between the adhesive and the glass.

A composite element with greater rigidity is advantageous in particular if, when using the composite element as an insulating-glass unit, for example, a deflection or deflections can occur as the result of wind loads. This may occur, for example, in the dividing area in two-part windows or in the non-clamped area in facades. In this case, it may be necessary, for example, to structurally frame the middle area which, according to the prior art, is currently achieved by larger frame cross-sections or additional reinforcements in the frame profile. The basis of measurement for the deflection must satisfy the condition <|200, wherein | is the length of the glass edge. With glass connected in a shear-resistant manner according to a design according to the present invention, having a composite element or an advantageous embodiment for this purpose, it is possible to entirely or partially omit the currently required additional reinforcements and/or to reduce frame cross-sections or, in the case of identical frame cross-sections and reinforcements, to produce on a larger scale. This results partially in substantial material savings and is also visually pleasing.

It should be noted that the larger the space between the panes, the stiffer the glass becomes. The calculation in this case is not linear, the distance is introduced into the calculation in the third power.

In addition, it may be provided that the profile element has a box-like base body with respect to its cross-section. The base body may form its box-like shape with respect to its cross-section, in that the base body has a generally rectangular or square cross-section. Moreover, it is conceivable that the inside of the base body is at least partially hollow or includes and/or forms a hollow space, wherein the hollow space is partially permeable, for example, and/or is perforated, and wherein the hollow space is also filled at least partially with a hygroscopic material, for example. Furthermore, the hollow space may be coated, at least on the side opposite of the glass spacing, with a metal film, or the metal film may be integrated in the matrix, which enhances the water and gas diffusion impermeability and therefore prolongs the serviceability of the multi-pane insulating glass (MIG).

Moreover, it is also possible that a first cross-piece and/or a second cross-piece is molded on the base body, wherein at least one side wall of the first cross-piece forms at least partially the first connecting surface, and/or wherein at least one side wall of the second cross-piece forms at least partially the first connecting surface.

It may be further provided that the first pane element and the second pane element are made at least partially of glass and the profile element at least partially of a glass fiber reinforced material, in particular, at least partially of a glass fiber composite material, preferably at least partially of glass fiber reinforced plastic. This has the advantage that both the pane elements and the profile element have a substantially identical thermal expansion coefficient. This in turn also includes the advantage that heat-related stresses may be minimized.

In addition, the present invention relates to an insulating-glass unit having the features of claim 10. Accordingly, it is provided that an insulating-glass unit is furnished with at least one composite element according to one of claims 1 through 9.

Moreover, the present invention relates to a profile element having the features of claim 11. Accordingly, it is provided that a profile element has or is formed having the profile element features according to one of the claims 1 through 9.

In addition, the present invention relates to a window having the features of claim 12. Accordingly, it is provided that a window is furnished having at least one composite element according to one of the claims 1 through 9, and/or having at least one insulating-glass unit according to claim 10 and/or having at least one profile element according to claim 11.

Moreover, the present invention relates to a door having the features of claim 13. Accordingly, it is provided that a door is furnished having at least one composite element according to one of the claims 1 through 9, and/or having at least one insulating-glass unit according to claim 10 and/or having at least one profile element according to claim 11.

In addition, the present invention relates to a method for producing a composite element having the features of claim 14. Accordingly, it is provided that to produce a composite element, in particular a composite element for an insulating-glass unit, at least one first pane element and at least one second pane element, as well as at least one first profile element are joined, in particular joined by means of adhesion, wherein the profile element includes at least one first connecting surface and/or at least one second connecting surface, wherein the first and/or the second connecting surface is provided and designed for applying and/or accommodating a first connecting means, wherein provided adjacent the first connecting surface is a third connecting surface for applying and/or accommodating a second connecting means, and/or adjacent the second connecting surface a fourth connecting surface is provided for applying and/or accommodating a second connecting means, and wherein the first pane element and the second pane element may be connected or are connected by means of the profile element and the first connecting means and/or the second connecting means, wherein the composite element includes in particular the features according to one of the claims 1 through 9.

The present invention also relates to a method for producing an insulating-glass unit having the features of claim 15. Accordingly, it is provided that to produce an insulating-glass unit whereby at least one composite element according to one of claims 1 through 9 or a composite element obtained by the method according to claim 14 is used.

### BRIEF DESCRIPTION OF THE DRAWING

Exemplary embodiments of the invention are explained in greater detail below with reference to the drawings, in which:

FIG. 1 is a schematic depiction of a part of an insulating glass according to the present invention in cross-section.

Only those elements essential to the immediate understanding of the invention are shown.

### IMPLEMENTATION OF THE INVENTION

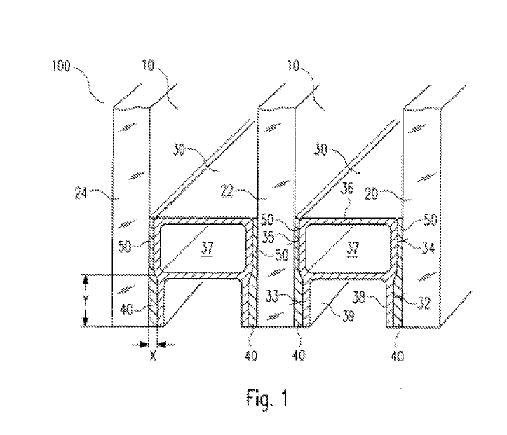

FIG. 1 shows an insulating-glass unit 100 having at least one composite element 10, which is formed by the pane elements 20 and 22 and the profile element 30.

The insulating-glass unit 100 in the embodiment shown in FIG. 1 includes a third pane element 24 and an additional profile element 30, which connects the third pane element 24 with the pane element 22. The two profile elements 30 in this exemplary embodiment are structurally identical. It is also conceivable that the space between the pane elements 20, 22, 24 is filled with a gas. Such a gas may be argon, for example.

The second and the third pane element 22, 24 together with the additional profile element situated therebetween, form an additional composite element 10′, which is substantially identical to the first composite element 10 and which is described in detail below:

The composite element comprises the first pane element 20 and a second pane element 22, as well as the first profile element 30 or spacer 30. The profile element 30 includes a first connecting surface 32 and a second connecting surface 33, wherein the first and the second connecting surfaces 32, 33 are provided and designed for applying and accommodating a first connecting means 40.

The first connecting means 40 in this arrangement is an adhesive having a hardness of approximately 90 Shore A. The adhesive in the example shown is a two-component adhesive system, which based on a so-called acrylic double performance (ADP) polymer technology. The first component in this system is a reactive monomer, for example, and the second component serves as an initiator, for example. In this case, the polymerization may occur during mixing with the aid of a static mixer. A commercially available example of such an adhesive is SikaFast-5211. Calculations and tests with the exemplary embodiment shown in FIG. 1 and with a two-component adhesive system (SikaFast-5211) have shown that surprisingly a rigidity can be achieved which is approximately 10 times greater compared to conventional constructions.

The first and the second connecting surfaces 32, 33 are formed as a recess, constituted in such a way that it is recessed relative to the third and/or fourth connecting surface 34, 35 with respect to the support surface on the first or second pane element 20, 22.

The recess in this case is a joint or a step-like recess. The smaller the depth of the joint x, the more shear-resistant the composite becomes. However, it is the case that as the depth of the joint x decreases, the stress in the adhesive and glass increases. For this reason, the calculation is not linear. The corner regions may be particularly critical, because it is there that the highest stresses can occur. At the same time, the joint width y plays a comparatively minor role in terms of the shear-resistant composite. By dimensioning the joint width y, it is possible to control the stress in the adhesive and the glass. Here, it is the case that the larger the area (as result of the joint width and circumference), the lower the stress in the adhesive joint and between the adhesive 40 and the glass of the pane elements 20, 22.

Adjacent to the first connecting surface 32, a third connecting surface 34 for applying and/or accommodating a second connecting means 50 is provided, and adjacent to the second connecting surface 33, a fourth connecting surface 35 for applying and/or accommodating a second connecting means 50 is provided.

The first pane element 20 and the second pane element 22 are connected by means of the profile element 30 and the first connecting means 40 and of the second connecting means 50, in this case, polyisobutylene (PIB).

The profile element 30 has a box-like base body 36 with respect to its cross-section. In this case, the inside of the base body 36 is at least partially hollow and includes a hollow space 37. The hollow space 37 is at least partially permeable and perforated and is filled with a hygroscopic material. Moisture can be absorbed as a result.

A first cross-piece 38 and a second cross-piece 39 are molded on the base body 35, wherein one side wall of the first cross-piece 38 forms at least partially the first connecting surface 32, and wherein a side wall of the second cross-piece 39 forms at least partially the second connecting surface 33.

The first pane element 20 and the second pane element 22 (as well as the third pane element 24) are each made at least partially of glass, and the profile element 30 is also made of a glass fiber reinforced plastic.

### LIST OF REFERENCE NUMERALS

10 Composite element
10′ Composite element
20 First pane element
22 Second pane element
24 Third pane element
30 Profile element
32 First connecting surface
33 Second connecting surface
34 Third connecting surface
35 Fourth connecting surface
36 Base body
37 Hollow space
38 First cross-piece
39 Second cross-piece
40 First connecting means
50 Second connecting means
100 Insulating-glass unit
x Joint depth
y Joint width

1. A composite element for an insulating-glass unit, the composite element comprising:
at least one first pane element at least one second pane element. and at least one first profile element, wherein the profile element includes at least one first connecting surface and/or at least one second connecting surface, wherein the first and/or the second connecting surface is constituted configured for applying and/or accommodating one first connecting means, wherein:
adjacent to the first connecting surface, a third connecting surface for applying and/or accommodating a second connecting means is provided, and/or
adjacent to the second connecting surface, a fourth connecting surface is provided for applying and/or accommodating a second connecting means; and
wherein the first pane element and the second pane element are configured for connection by means of the profile element, the first connecting means, and/or the second connecting means.

2. The composite element according to claim 1, wherein the first connecting means has a hardness of approximately 60 Shore A.

3. The composite element according to claim 1, wherein the first connecting means is an adhesive, selected from a group of adhesives which includes silicone.

4. The composite element according to claim 1, wherein the second connecting means comprises:
at least partially polyisobutylene and/or acryl.

5. The composite element according to claim 1, wherein the first and/or the second connecting surface is formed at least partially as a recess, in particular as a recess, which is created such that it is recessed relative to the third and/or fourth connecting surface, and in relation to a support surface on the first or second pane element.

6. The composite element according to claim 1, wherein the profile element has a box-like base body with respect to the cross-section.

7. The composite element according to claim 6, wherein the inside of the base body is at least partially hollow, or includes and/or forms a hollow space, wherein the hollow space is at least partially permeable and/or perforated, and wherein the hollow space is filled at least partially with a hydroscopic material.

8. The composite element according to claim 6, wherein a first cross-piece and/or a second cross-piece is molded on the base body, wherein at least one side wall of the first cross-piece forms at least partially the first connecting surface and/or wherein at least one side wall of the second cross-piece forms at least partially the second connecting surface.

9. The composite element according to claim 1, wherein the first pane element and the second pane element are made at least partially of glass and the profile element is made at least partially of a glass fiber reinforced material, selected in particular from a group of materials which includes glass fiber reinforced plastic.

10. An insulating-glass unit having at least one composite element according to claim 1.

11. A profile element having the profile element features according to claim 1.

12. A window having at least one composite element according to claim 1.

13. A door having at least one composite element according to claim 1.

14. A method for producing a composite element, the method comprising:
providing at least one first pane element, at least one second pane element and at least one first profile element, wherein the profile element includes at least one first connecting surface and/or at least one second connecting surface, wherein the first and/or the second connecting surface is configured for applying and/or accommodating a first connecting means, wherein adjacent to the first connecting surface, a third connecting surface for applying and/or accommodating a second connecting means is provided and/or adjacent to the second connecting surface, a fourth connecting surface for applying and/or accommodating a second connecting means is provided; and
connecting the first pane element and the second pane element by the profile element; the first connecting means and/or the second connecting means.

15. A method according to claim 14, comprising:
producing an insulating-glass unit with the composite element.

16. The composite element according to claim 1, wherein the first connecting means has a hardness of greater than or equal to approximately 60 Shore A.

17. The composite element according to claim 1, wherein the first connecting means has a hardness of greater than or equal to approximately 70 Shore A.

18. The composite element according to claim 1, wherein the first connecting means has a hardness of greater than or equal to approximately 90 Shore A.

19. The composite element according to claim 2, wherein the first connecting means is an adhesive selected from a group of adhesives, which includes silicone.

20. The composite element according to claim 19, wherein the second connecting means comprises:
at least partially polyisobutylene and/or acryl.
